(19) United States
(12) Patent Application Publication
(10) Pub. No.: US 2023/0284588 A1
(43) Pub. Date: Sep. 14, 2023

(54) FLOOR LINER TRAY FOR ANIMAL ENCLOSURE

(71) Applicant: L.O.F., Inc., Elkhart, IN (US)

(72) Inventor: Shawn C. Scott, Greenwood, IN (US)

(21) Appl. No.: 17/693,833

(22) Filed: Mar. 14, 2022

(51) Int. Cl. A01K 1/01

(52) U.S. Cl. CPC A01K 1/01

(57) ABSTRACT

A tray is adapted to be positioned at a lower side of an animal enclosure, such as a cage or a kennel for a dog, to provide a stable and supportive surface for the dog. The tray includes a base having a horizontal support surface with one or more sides. Each side includes an angled portion and an upright portion. The angled portion extends upward and outward from the support surface to the upright portion, and allows a connecting feature of the cage, such as a loop that protrudes into the interior of the cage to connect the sides of the cage to the lower side of the cage, to be at least partially positioned under and in contact with the angled portion to thereby provide stable angled support to the tray. The upper portion includes a hem that forms a rounded top edge.

### BACKGROUND AND FIELD OF THE INVENTION

The present invention is directed to a floor liner tray that is adapted to be used with an animal cage, crate, or enclosure.

Various animals including household pets such as dogs and cats, are often placed in an enclosure such as a cage or kennel made of a series of metal wires or a grate. A liner may be positioned at the bottom side of the enclosure to form the bottom and/or to cover the metal wires or grate to thereby provide a more comfortable lower surface or floor to support the animal within the enclosure.

### SUMMARY OF THE INVENTION

The present invention provides a tray adapted to be inserted into an animal enclosure, such as a cage, crate or dog kennel used to house or contain a dog, and positioned on or near a lower surface of the cage to thereby cover at least a portion of the lower surface of the cage, or form the bottom of such an enclosure. The tray includes a base having a horizontal support surface that provides a lower support surface for the animal. At least one side is connected to the support surface, and includes an angled portion and an upright portion. The angled portion is disposed between the support surface and the upright portion. The upright portion includes a hem that defines a rounded top edge of the at least one side.

According to an aspect of the present invention, the hem includes an upwardly extending section and a downwardly extending section that is oriented parallel to the upwardly extending section.

In another aspect, the angled portion has a bottom angled surface that may come into contact with a portion of the enclosure.

In yet another aspect, the rounded top edge of the hem couples the upwardly extending section of the hem to the downwardly extending section of the hem.

In still another aspect, the at least one side surrounds the entire perimeter of the base.

In a further aspect, the angled portion extends at an upward angle away from an outer edge of the base.

In yet a further aspect, an upper rounded bend connects the angled portion to the upright portion.

In still a further aspect, a lower rounded bend connects the base to the angled portion.

In an additional aspect, the downwardly extending portion terminates in a distal end that is located halfway between a top side of the upper rounded bend and the rounded top edge in a vertical direction.

In another additional aspect, the angled portion is oriented at a 40 degree vertical angle relative to the support surface.

In another form of the present invention, a tray is adapted to be positioned at a lower side of an animal enclosure and includes a base having a horizontal support surface and four connected sides. Each side includes an upright portion with a hem defining a rounded top edge, an angled portion that is connected between the base and the upright portion, an upper rounded bend connected between the angled portion and the upright portion, and a lower rounded bend connected between the base and the angled portion. The angled portion has a bottom angled surface that may come into contact with a portion of the enclosure

According to one aspect, the tray includes four inside corners that are each formed where an adjacent pair of sides are welded together. Each corner includes an angled junction that is formed where an adjacent pair of angled portions are welded together, and an upright junction that is formed where an adjacent pair of upright portions are welded together. The angled junction extends upwardly and outwardly away from the base to the upright junction, while the upright junction extends straight upward at a 90 degree angle relative to the support surface.

In another aspect, the tray has four rounded outer lower junctions that are located on an outer surface of the tray where the base and a respective angled junction meet or are connected.

In yet another aspect, the tray has four rounded outer upper junctions that are located on the outer surface of the tray where a respective angled junction and a respective upright junction meet or are connected.

In still another aspect, each upright junction further includes a rounded to corner that is rounded on both an inner surface of the tray and a top surface of the tray.

Accordingly, the floor liner tray in accordance with the present invention provides a safe and stable lower support surface for an animal housed or contained within an enclosure to stand, sit, lay, and move around on. A base includes a horizontal support surface that is connected to one or more outer sides that have an angled portion and an upright portion. The angled portion extends upwardly and outwardly away from the base to the upright portion so that a loop or other connective feature of the enclosure that may protrude into the enclosure near the bottom surface of the enclosure may provide support to the tray via contact with a lower surface of the angled portion. The upright portion has a hem that defines a rounded top edge to the side to thereby reduce the likelihood that the animal could be inadvertently cut or harmed by a sharp or jagged edge of the tray. Many other features of the tray are also smooth and/or curved to prevent injury to the animal and/or damage to the enclosure.

These and other objects, advantages, purposes and features of this invention will become apparent upon review of the following specification in conjunction with the drawings.

### BRIEF DESCRIPTION OF THE DRAWINGS

FIG. 1 is a perspective of a tray in accordance with the present invention, where the tray is shown positioned at a lower surface of a dog cage;

FIG. 2A is a top perspective of the tray of FIG. 1;

FIG. 2B is a close-up perspective view of the area designated in FIG. 2A showing an inside corner of the tray of FIG. 1;

FIG. 3A is a bottom perspective view of the tray of FIG. 1;

FIG. 3B is a close-up perspective view of the area designated in FIG. 3A showing an outside corner of the tray of FIG. 1;

FIG. 4A is a side elevation view along a long side of the tray of FIG. 1;

FIG. 4B is an enlarged view of the area designated in FIG. 4A showing a hem of the tray of FIG. 1;

FIG. 5 is a side elevation view along a short side of the tray of FIG. 1;

FIG. 6 is a side elevation view along the opposite short side of the tray of FIG. 1 from that shown in FIG. 5;

FIG. 7 is a top plan view of the tray of FIG. 1;

FIG. 8 is a bottom plan view of the tray of FIG. 1;

FIG. 9 is a perspective view of another tray in accordance with the present invention, where the tray has an indeterminate width;

FIG. 10 is a top plan view of the tray of FIG. 9;

FIG. 11 is a bottom plan view of the tray of FIG. 9;

FIG. 12 is a perspective view of another tray in accordance with the present invention, where the tray has an indeterminate length;

FIG. 13 is a top plan view of the tray of FIG. 12; and

FIG. 14 is a bottom plan view of the tray of FIG. 12.

### DESCRIPTION OF THE PREFERRED EMBODIMENTS

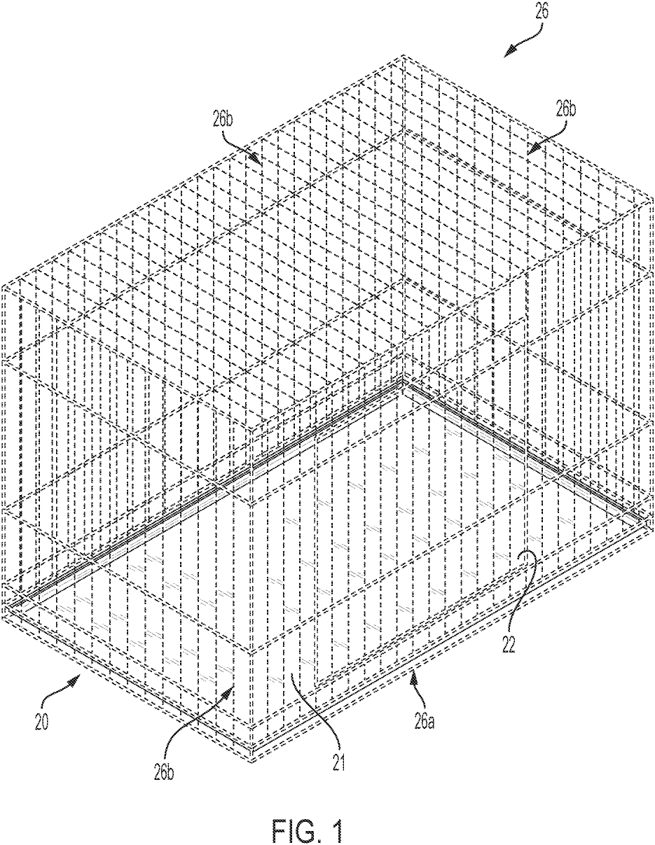

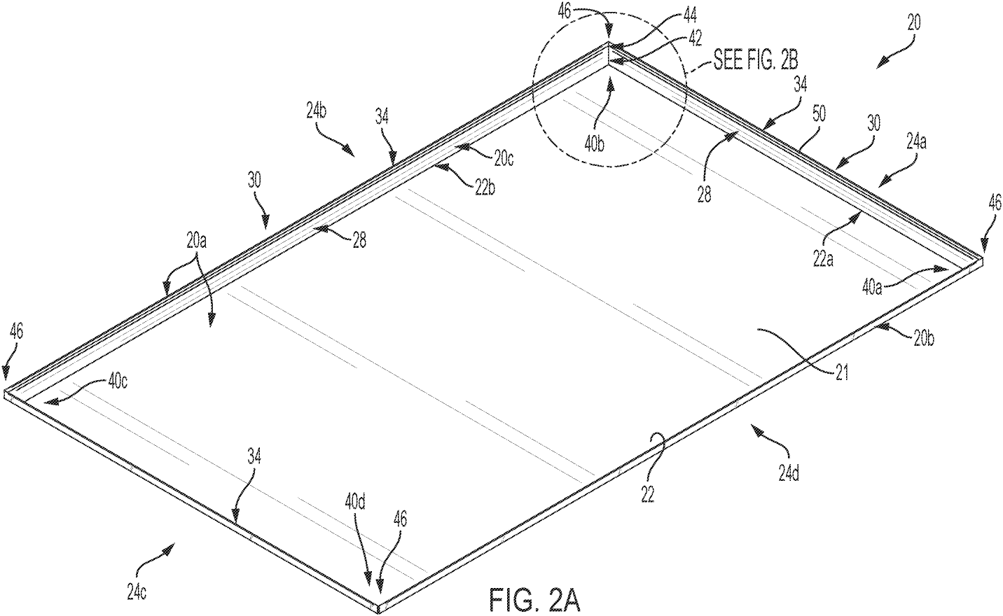

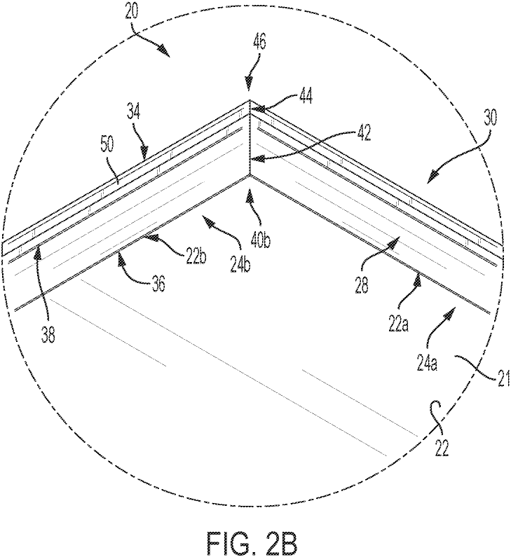

The present invention will now be described with reference to the accompanying figures, wherein the numbered elements in the following written description correspond to like-numbered elements in the figures. As shown in the preferred embodiment of FIGS. 1 and 2A, an animal enclosure floor liner, pan, or tray in the form of tray 20 includes a horizontal base or bottom 21 forming a support surface 22 and has four sides in the form of two short sides 24a, 24c and two long sides 24b, 24d. Tray 20 may be placed into an animal enclosure, kennel, housing, or cage such as cage 26, where cage 26 is used to house a dog or other pet, to thereby form a floor and/or cover a lower wire mesh surface 26a of the cage 26 in order to provide the dog with a more comfortable and supportive surface to stand, sit, lay or move around on. Sides 24a-d are connected to one another and extend upward around the perimeter of support surface 22 such that any liquid or waste will remain contained within the perimeter of sides 24a-d. Cage 26 includes side walls 26b that may be connected to lower surface 26a of cage 26 in various manners, such as loops that wrap around a portion of lower surface 26a, such as a wire that forms part of lower surface 26a, or other types of latches, clips and the like. The loops extend into the interior of cage 26 and may make unavoidable or inadvertent contact with a lower surface of a floor liner at a substantially perpendicular angle or in an unstable fashion.

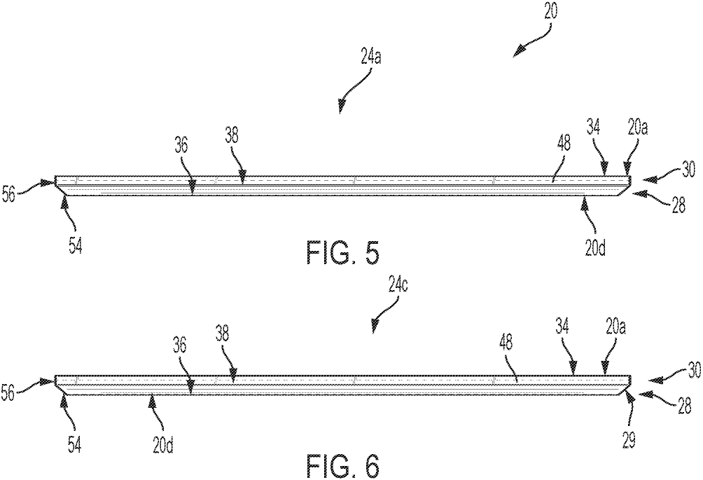

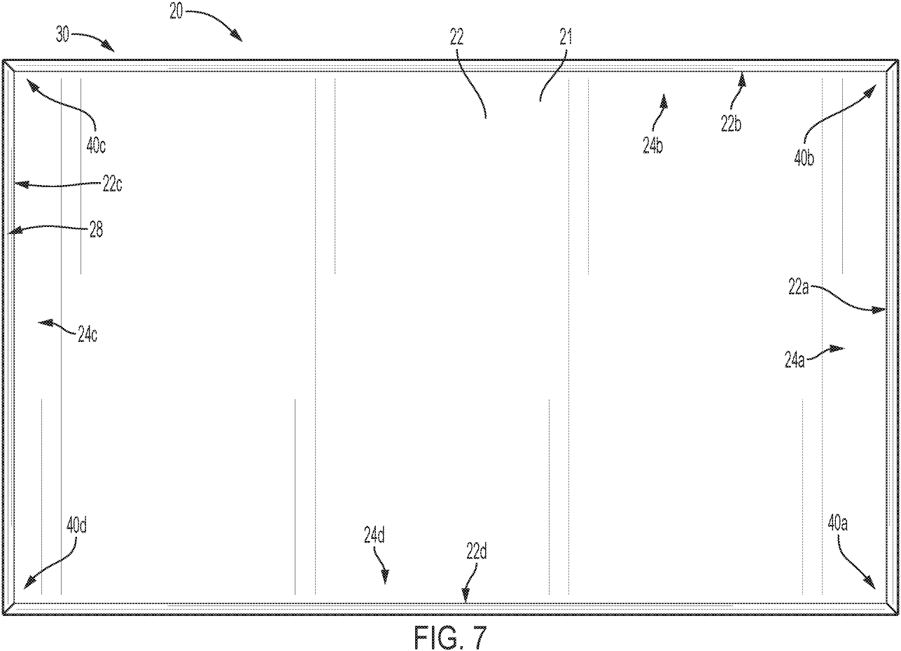

Referring to FIGS. 1-2A, 3A, 4A, and 5-8, support surface 22 of tray 20 is adapted to provide a comfortable and supportive lower support surface for an animal, such as a dog. Four sides 24a-d are connected at each outer edge 22a-d of base 21. Each side 24a-d includes an upwardly angled or inclined portion 28 connected to an upright portion 30. Each angled portion 28 is attached to a respective outer edge 22a-d of base 21, and in the illustrated embodiment extends vertically upward and laterally outward relative to surface 22. Each upright portion 30 is connected to a respective angled portion 28, and extends vertically upward relative to surface 22. Each upright portion 30 includes a hem 50 that is bent or folded over to define a rounded top edge 34 at a top perimeter or surface 20a of tray 20. Tray 20 includes top surface 20a, an outer surface 20b, an inner surface 20c, and a bottom surface 20d. Top surface 20a is defined by the uppermost point of tray 20 at each point across the horizontal footprint of tray 20. Outer surface 20b is defined by the outermost surface of each side 24a-d. Inner surface 20c is defined by the innermost surface of each side 24a-d. Bottom surface 20d is defined by the bottom surface of base 21 opposite support surface 22.

Referring to FIGS. 1-2A, 3A, 7, and 8, in the illustrated embodiment tray 20 is formed from a substantially rigid and planar metal sheet that is cut or stamped and then bent into shape and welded at the corners, where the sheet may comprise stainless steel, galvanized steel, aluminum, or another material that is not susceptible to being damaged due to excessive chewing and/or scratching by an animal and is resistant to liquids. In the present embodiment the material is 0.037 inches thick, but can be configured to be thicker or thinner. Horizontal support surface 22 includes a substantially rigid and planar piece of material, such as a rectangular piece of metal or another material. In the illustrated embodiment, surface 22 is substantially flat and rectangular in shape. However, it should be appreciated that a support surface could have more or less than four outer edges, may be circular or have curved outer edges, and may have ridges, holes, depressions, or other features rather that result in a support surface not being completely flat.

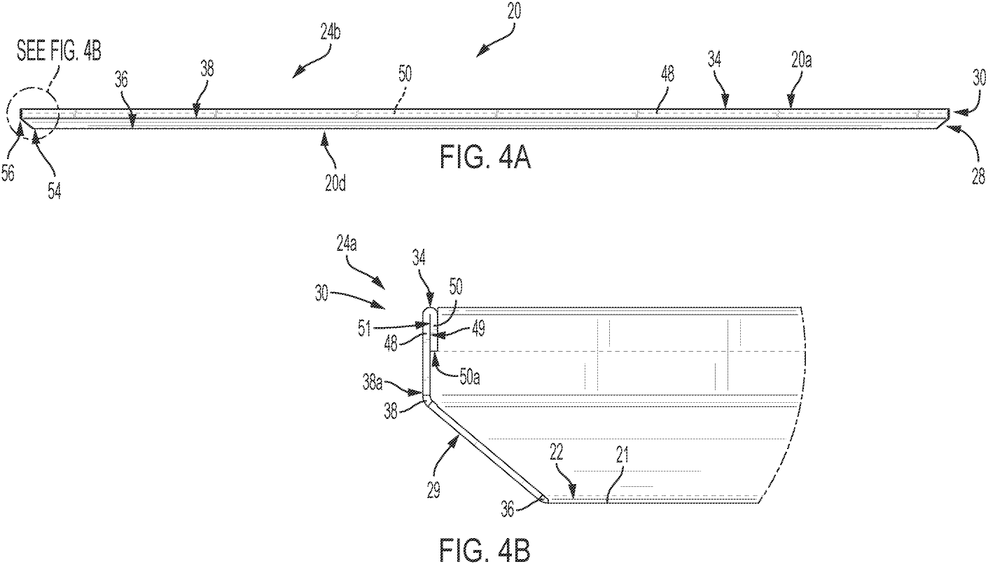

Referring to FIGS. 1-2A, and 5-7, each angled portion 28 is connected to a respective outer edge 22a-d of base 21, and extends upwardly and outwardly away from surface 22. In the illustrated embodiment, upward portion 30 extends substantially straight upward in the vertical direction approximately 0.5 inches from an upper rounded bend 38 (discussed below) to rounded top edge 34. As shown in FIGS. 4A and 4B, the connection or transition area between surface 22 and angled portion 28 takes the form of a lower rounded bend 36 that has curved inner and outer radii. Likewise, the connection or transition area between angled portion 28 and upright portion 30 takes the form of upper rounded bend 38 that has curved inner and outer radii. Rounded bends 36, 38 provide a smooth surface that helps to prevent fluid, such as animal waste or spilled drinking water, from pooling or collecting in areas other than surface 22, while also reducing the likelihood of the dog injuring itself due to contact with a sharp or jagged edge. As noted above, a tray may include a base or bottom having more or less than four outer edges, or having curved outer edges. It should be appreciated that one or more sides will be attached or connected to such a base at or near the perimeter or outer edges of the base in a manner that corresponds to the geometry of the support surface. However, it is within the scope of the invention that one or more perimeter portions or outer edges of a support surface may lack a side. Additionally, the angles and/or curvature of both the angled portion and upright portion, as well as how these portions are connected to adjacent components, may vary within the scope of the invention.

Referring now to FIGS. 2A and 2B, each pair of adjacent sides 24a-d are connected at corresponding inside corners 40a-d. Each corner 40a-d includes an angled junction 42 where a pair of adjacent angled portions 28 meet, and an upright junction 44 where a pair of adjacent upright portions 30 meet. Junctions 42, 44 may be an integral portion of a pair of adjacent sides 24a-d where sides 24a-d are formed through a bending and/or molding process, and may be formed by welding the ends or edges of a pair of adjacent sides 24a-d together. Angled junctions 42 extend vertically upward at the same angle as angled portions 28, discussed below, and laterally outward from a pair of adjacent outer edges 22a-d of surface 22 such that the respective lateral angle between angled junction 42 and either outer edge 22a-d among any pair of adjacent outer edges 22a-d is identical, which in the illustrated embodiment is a 135 degree lateral angle. Upright junction 44 extends substantially straight upward in the vertical direction, which is approximately a 90 degree vertical angle relative to surface 22. Each upright junction 44 has a rounded inside top corner 46 that has curved, smooth, and/or rounded surfaces on both the inner surface 20c of tray 20 and the portion of top surface 20a of tray 20 that corresponds to each inside top corner 46.

As noted above, an animal enclosure, kennel, or cage 26, may often times include connecting features, such as loops, that connect side walls of the enclosure to a lower surface of the enclosure. These connecting features may protrude into the enclosure such that a floor liner placed into the enclosure may at least partially rest on the connecting features. Referring to FIGS. 2A and 4A-6, in the illustrated embodiment angled portions 28 extend upwardly away from surface 22 at a 140 degree interior angle, with a supplementary exterior angle of 40 degrees relative to a plane formed by base 21. It should be appreciated that this angle may vary by manufacturing tolerances associated with bending operations, or may be alternatively configured by some amount, such as plus or minus 5 degrees or more. Tray 20 is sized with an overall length and width such that when tray 20 is positioned on or near lower surface 26a of cage 26, the upper portions 30 are positioned in proximity to the upright vertical walls of the cage 26. As such, a gap is formed underneath angled portion 28 and the lateral outward extension of angled portions 28 extend sides 24a-d of tray 20 to the sides 26b of cage 26. It should be appreciated that an angled portion extending upward relative to a support surface may accommodate a portion of a cage. As such, an angled portion could extend away from a support surface at alternative angles and/or be curved upward relative to a support surface while remaining within the scope of the present invention. Furthermore, each side of a tray is formed from a bending process that creates portions of varying angles of the side between a base of the tray and a top edge of the side. In the illustrated embodiment, sides 24a-d are formed to have two bends forming angled portions 28 and upright portions 30 that are angled relative to support surface 22 as described above, plus an additional bend for hem 50. However, it should be understood that a side may be formed with more than two bends to have more than two portions, and/or may be formed to have portions of the side oriented relative to a support surface at various angles. Specifically, both an angled portion and/or an upright portion may be formed to extend away from a support surface at angles other than what has been described above. Additionally, one or more additional portions of a side that are oriented at a different angle than an angled portion and/or an upright portion may be formed in the side.

Referring again to FIGS. 2A and 4A-6, each upper portion 30 includes an upwardly extending section 48 that extends vertically upward from a respective angled portion 28 and parallel to a downwardly extending section forming a hem 50. Both upwardly extending section 48 and downwardly extending section 50 are approximately 0.037 inches thick. Upwardly extending section 48 and downwardly extending section 50 are connected by rounded top edge 34 at top surface 20a of tray 20. Upwardly extending section 48 has an inner hem surface 49 that is in contact with an outer hem surface 51 of downwardly extending section 50. Downwardly extending section 50 terminates at a distal end 50a that is approximately 0.22 inches below rounded top edge 34, which is approximately half the vertical distance between a top side 38a of upper rounded 38 and rounded top edge 34. Because each upper portion 30 terminates in a folded or bent hem 50 rather than a flat or straight edge, the risk of injury to the dog due to contact with a sharp or jagged edge is further reduced. It should be appreciated that an upper portion could be sanded, smoothed, or otherwise formed to have smooth or rounded edges without a hem.

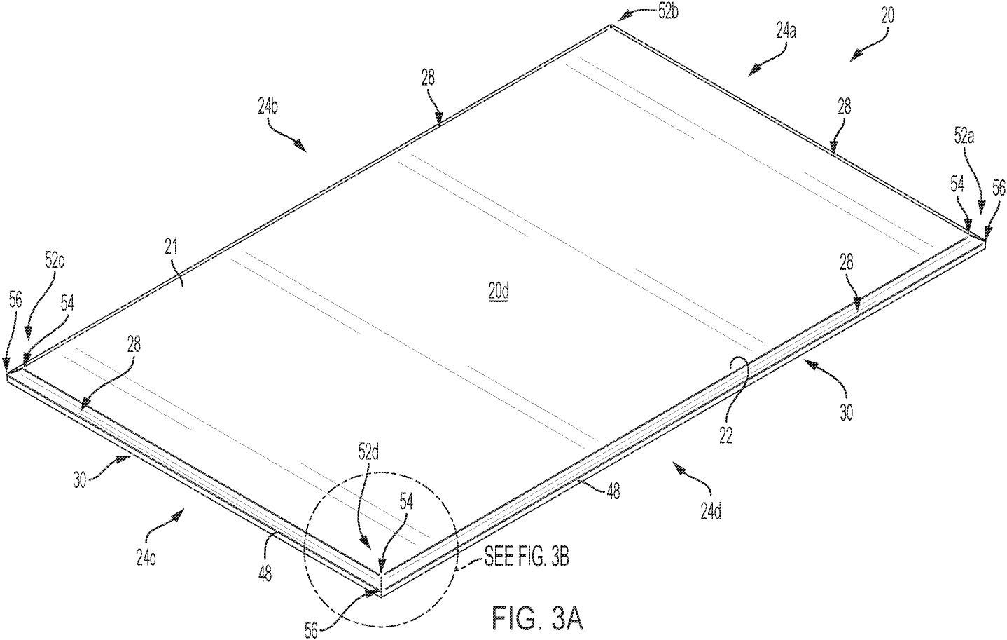

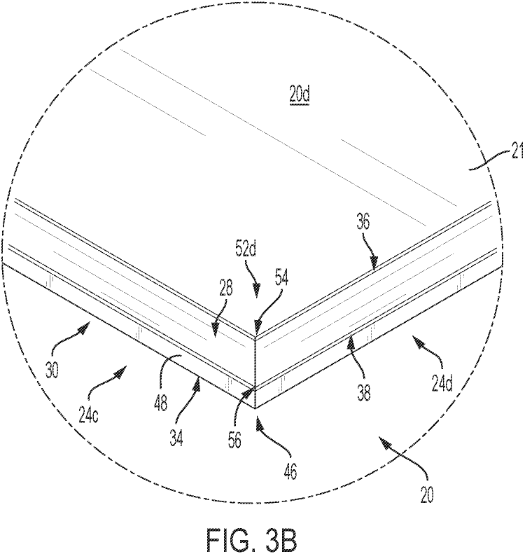

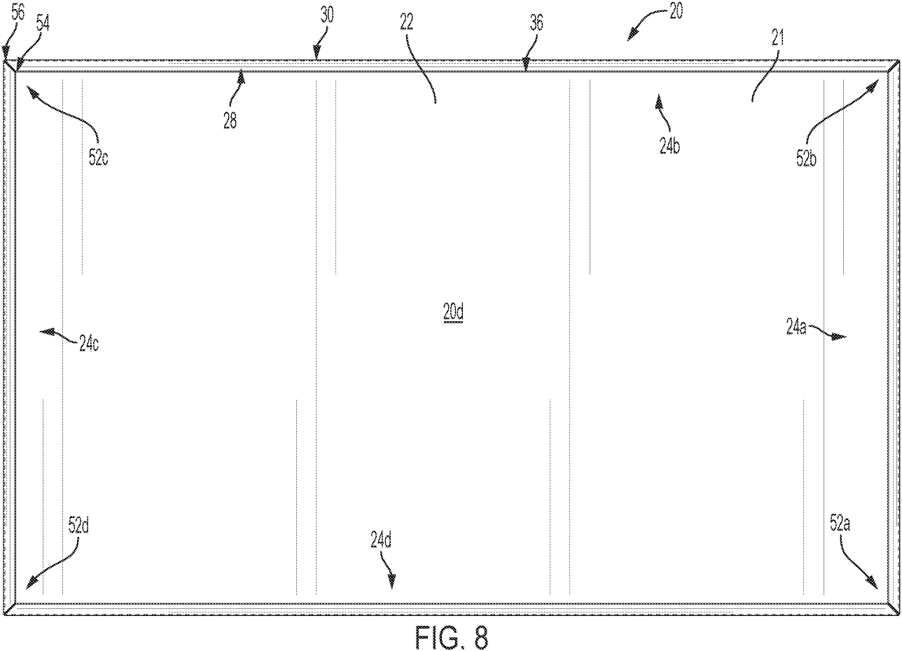

As noted above, many of the edges and corners of tray 20 that are accessible to the dog are substantially smooth and rounded so as to prevent cuts or other injuries due to the dog chewing on or otherwise coming into contact with an edge or corner of tray 20. In addition to the accessible areas of tray 20 being smooth and/or curved, areas of tray 20 that are inaccessible to the dog are also rounded or smooth so as to prevent scratches or damage to portions of a cage 26 or other surface that tray 20 may come into contact with. For example, with reference to FIGS. 3A and 8, a series of outside corners 52a-d located on outer surface 20b of tray 20 include a respective rounded outer lower junction 54 where surface 22 and a respective angled junction 42 meet or connect, and rounded outer upper junction 56 where a respective angled junction 42 and a respective upright junction 44 meet or connect.

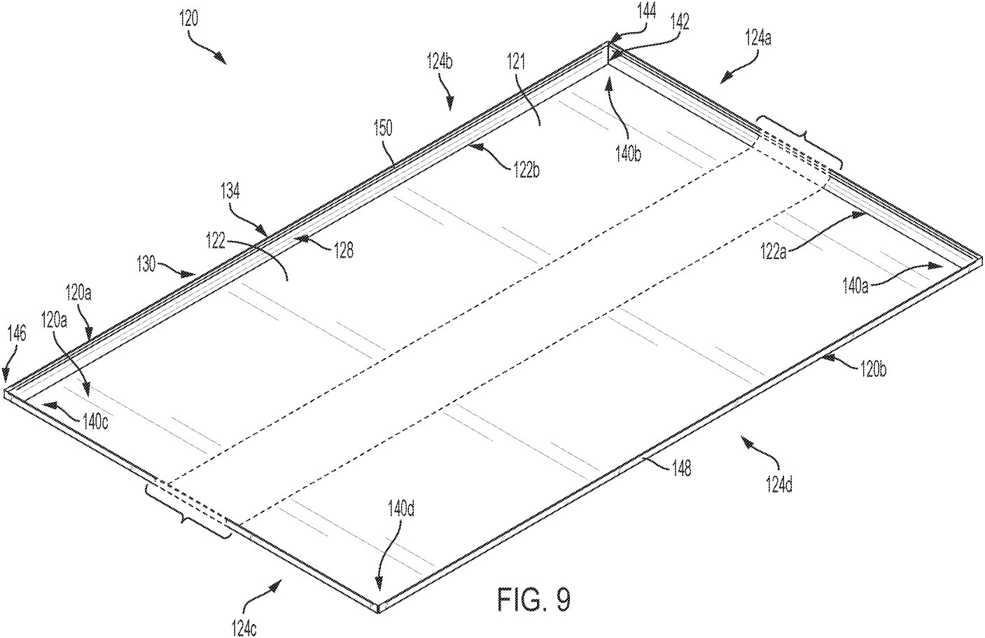

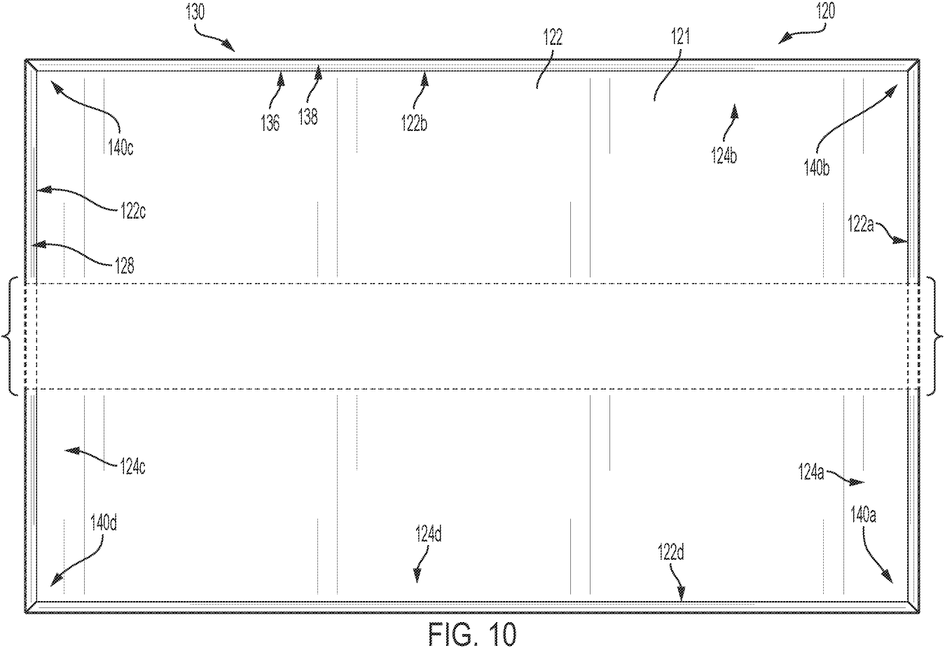

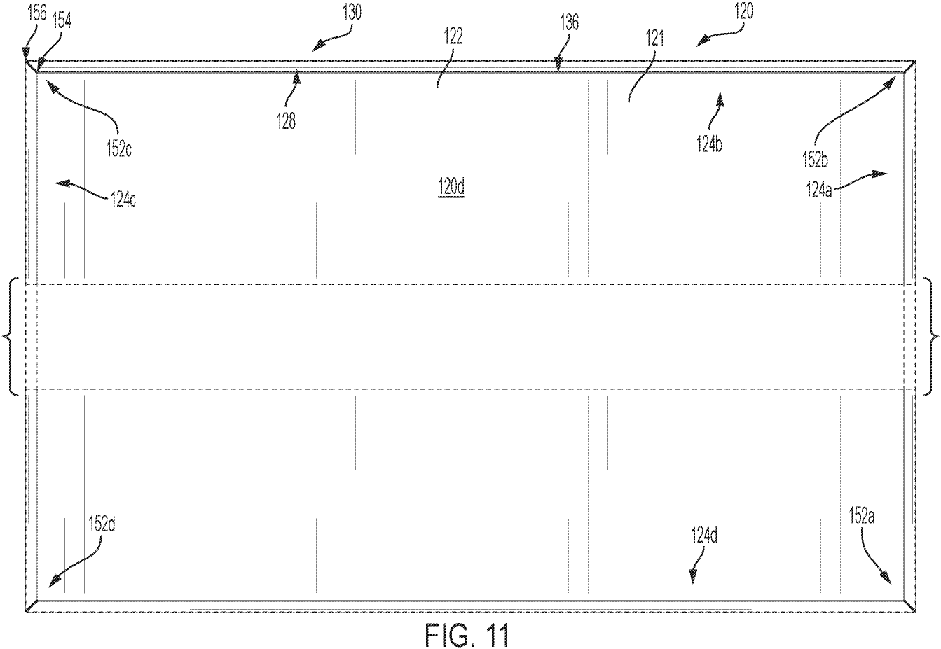

It should be understood that a tray may take on alternative forms in geometric characteristics of the tray may vary, such as alternative lengths and/or widths of the tray. For example, as shown in FIGS. 9-11, another tray 120 is shown that is similar to tray 20, with similar features of tray 120 relative to tray 20 being designated with like reference numbers, but with “100” added to each reference number of tray 120. Due to the similarities of tray 120 relative to tray 20, not all of the components and features of tray 120 are discussed herein. As shown, tray 120 has a base 121 with a horizontal support surface 122 and a pair of short sides 124a, 124c being of an indeterminate width. That is, the width of tray 120 may be greater or less than the width of tray 20. In addition, in like manner to tray 20, tray 120 also includes long sides 124b, 124d, angled portions 128, upright portions 130, hems 150, rounded top edge 134, lower rounded bends 136, upper rounded bends 138, inside corners 140a-d, angled junctions 142, upright junctions 144, rounded top corners 146, and outside corners 152a-d.

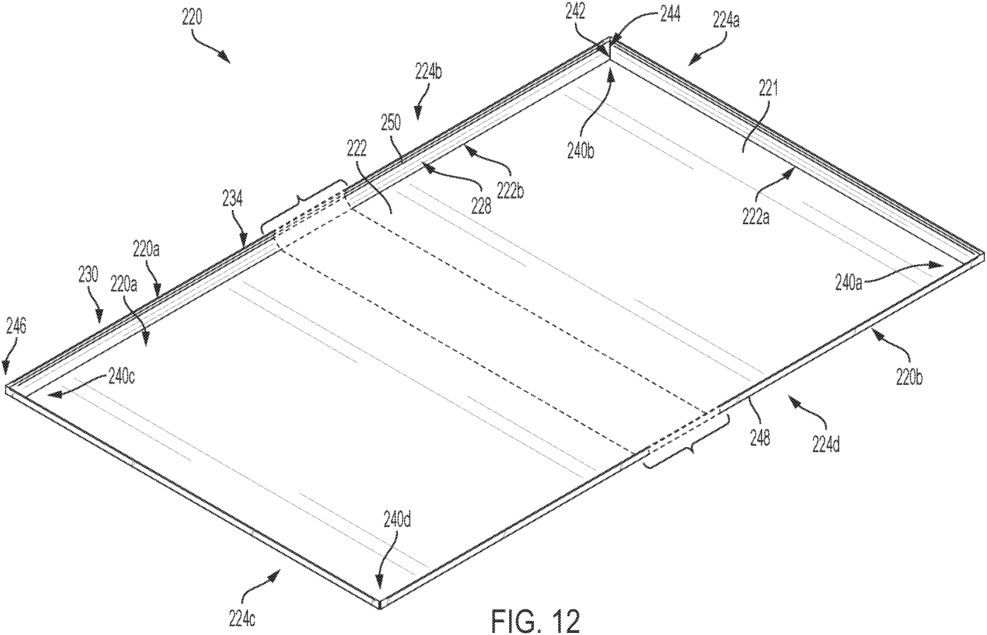

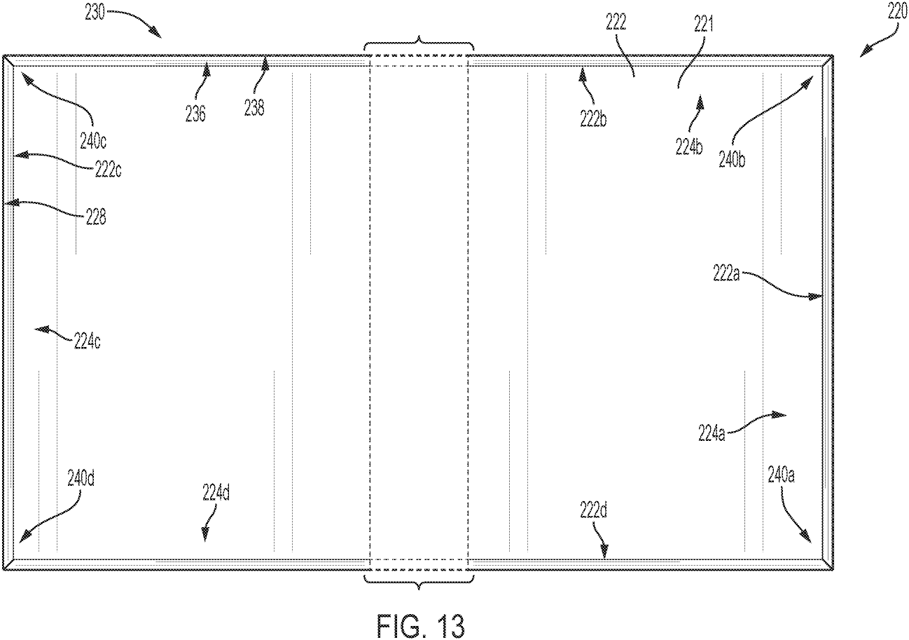

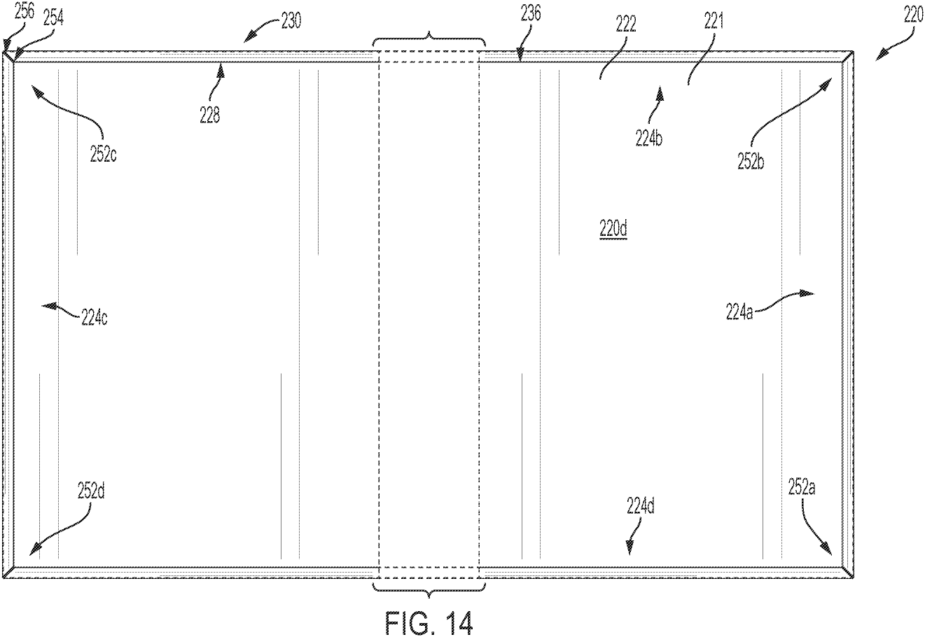

Referring now to FIGS. 12-14, another tray 220 is shown that is similar to tray 20, with similar features of tray 220 relative to tray 20 being designated with like reference numbers, but with “200” added to each reference number of tray 220. Due to the similarities of tray 220 relative to tray 20, not all of the components and features of tray 220 are discussed herein. As shown, tray 220 has a base 221 with a horizontal support surface 222 and a pair of long sides 224b, 224d being of an indeterminate length. That is, the length of tray 220 may be greater or less than the length of tray 20. In addition, in like manner to tray 20, tray 220 also includes short sides 224a, 224c, angled portions 228, upright portions 230, hems 250, rounded top edge 234, lower rounded bends 236, upper rounded bends 238, inside corners 240a-d, angled junctions 242, upright junctions 244, rounded top corners 246, and outside corners 252a-d.

It should be appreciated that although tray 20 has been discussed in connection with use in cage 26 which houses a dog, tray 20 may also be used with other types of animal enclosures that may house other animals, such as a cat, for example.

In accordance with aspects of the floor liner tray of the present invention, a horizontal support surface provides a lower support surface for an animal, such as a dog, in an enclosure or cage. Sides are connected to and extend from the support surface in a vertically upward and laterally outward direction, and include an angled portion and an upright portion. A connecting feature of the cage that connects one or more sidewalls of the cage to a lower surface of the cage is able to be positioned at least partially under and in contact with the angled portion to provide angled and movable or slidable support to the tray. A rounded top edge of the upright portion is defined by a bent or folded hem so as to prevent inadvertent injury to the dog due to contact with a sharp edge or corner of the tray.

Changes and modifications in the specifically described embodiments can be carried out without departing from the principles of the present invention which is intended to be limited only by the scope of the appended claims, as interpreted according to the principles of patent law including the doctrine of equivalents.

The embodiments of the invention in which an exclusive property or privilege is claimed are defined as follows:

1. A tray adapted to be positioned at a lower side of an animal enclosure, said tray comprising:
a base comprising a horizontal support surface; and
a side comprising:
an upright portion; and
an angled portion disposed between said base and said upright portion.

2. The tray of claim 1, wherein said upright portion comprises an upwardly extending section and a downwardly extending hem section that is oriented parallel to said upwardly extending section.

3. The tray of claim 2, wherein said angled portion comprises a bottom angled surface configured to come into contact with a portion of the enclosure.

4. The tray of claim 3, wherein said rounded top edge couples said upwardly extending section to said downwardly extending section.

5. The tray of claim 4, wherein said side surrounds the entire perimeter of said base.

6. The tray of claim 1, wherein said angled portion extends at an upward angle away from an outer edge of said base.

7. The tray of claim 6, further comprising an upper rounded bend disposed between said angled portion and said upright portion.

8. The tray of claim 7, further comprising a lower rounded bend having a curved inner radius and a curved outer radius disposed between said base and said angled portion.

9. The tray of claim 8, wherein said upright portion comprises an upwardly extending section and a downwardly extending hem section that is in physical contact with said upwardly extending section.

10. The tray of claim 9, wherein said downwardly extending portion terminates in a distal end that is located halfway between a top side of said upper rounded bend and said rounded top edge in a vertical direction.

11. The tray of claim 1, wherein said angled portion is oriented at a 40 degree vertical angle relative to said support surface, and wherein said upright portion is oriented at a 90 degree angle relative to said support surface.

12. A tray adapted to be positioned at a lower side of an animal enclosure, said tray comprising:
a base comprising a horizontal support surface; and
four connected sides, each side comprising:
an upright portion comprising a hem defining a rounded top edge;
an angled portion disposed between said base and said upright portion, and comprising a bottom angled surface configured to come into contact with a portion of the enclosure;
an upper rounded bend having a curved inner radius and a curved outer radius disposed between said angled portion and said upright portion; and
a lower rounded bend having a curved inner radius and a curved outer radius disposed between said base and a respective said angled portion.

13. The tray of claim 12, wherein each of said hems further comprise an upwardly extending section and a downwardly extending section that is oriented parallel to said upwardly extending section.

14. The tray of claim 13, further comprising four inside corners formed where an adjacent pair of said sides are welded together, each inside corner comprising an angled junction formed where an adjacent pair of said angled portions are welded together, and an upright junction formed where an adjacent pair of said upright portions are welded together, wherein said angled junction extends upwardly and outwardly away from said base to said upright junction, and wherein said upright junction is oriented at a 90 degree vertical angle relative to said support surface.

15. The tray of claim 14, wherein each of said angled junctions is oriented at a 40 degree vertical angle relative to said support surface.

16. The tray of claim 14, further comprising four rounded outer lower junctions, each of said outer lower junctions disposed on an outer surface of said tray where said base and a respective said angled junction are connected.

17. The tray of claim 16, further comprising four rounded outer upper junctions, each of said outer upper junctions disposed on said outer surface of said tray where a respective said angled junction and a respective said upright junction are connected.

18. The tray of claim 14, wherein each of said upright junctions comprise a rounded top corner that is rounded on both an inner surface of said tray and a top surface of said tray.

19. A steel tray adapted to be positioned at a lower side of a dog cage, said tray comprising:
a base comprising a horizontal support surface;
four connected sides that collectively surround the entire perimeter of said base, each side comprising:
an upright portion comprising an upwardly extending section having an inner hem surface, a downwardly extending section having an outer hem surface, and a rounded top edge that couples said upwardly extending section to said downwardly extending section, said upwardly extending section oriented parallel to said downwardly extending section, and said inner hem surface of said upwardly extending section in physical contact with said outer hem surface of said downwardly extending section; and
an angled portion disposed between said base and said upwardly extending section, and comprising a bottom angled surface configured to come into contact with a portion of the enclosure, said angled portion extending upwardly and outwardly away from an outer edge of said base; and
four inside corners formed where an adjacent pair of said sides are welded together, each inside corner comprising an angled junction formed where an adjacent pair of said angled portions are welded together, and an upright junction formed where an adjacent pair of said upright portions are welded together, wherein said angled junction extends upwardly and outwardly away from said base to said upright junction, and wherein said upright junction is oriented at a 90 degree vertical angle relative to said support surface.

20. The floor insert of claim 19, further comprising four rounded outer lower junctions and four rounded outer upper junctions, wherein each of said outer lower junctions is disposed on an outer surface of said tray where said base and a respective said angled junction are connected, and wherein each of said outer upper junctions is disposed on said outer surface of said tray where a respective said angled junction and a respective said upright junction are connected.
